(19) United States
(12) Patent Application Publication
(10) Pub. No.: US 2025/0309337 A1
(43) Pub. Date: Oct. 2, 2025

(54) METHOD FOR MANUFACTURING OXIDE-BASE SOLID ELECTROLYTE OF LITHIUM BATTERY

(71) Applicant: Shenzhen TXD Technology Co., Ltd., New Taipei City (TW)

(72) Inventor: ZHI FENG LUO, Shenzhen (CN)

(73) Assignee: Shenzhen TXD Technology Co., Ltd., New Taipei City (TW)

(21) Appl. No.: 18/658,991

(22) Filed: May 9, 2024

(30) Foreign Application Priority Data
Mar. 27, 2024 (TW) 113111544

(51) Int. Cl. H01M 10/0562; H01M 10/0525

(52) U.S. Cl. CPC H01M 10/0562; H01M 10/0525

(57) ABSTRACT

A method for manufacturing an oxide-base solid electrolyte of a lithium battery includes the steps of: placing a zirconium-contained compound and a lanthanum-contained compound into a first ball mill for grinding and then performing an oil bath assisted vacuum concentration and a first stage sintering operation to obtain a zirconium lanthanum compound; placing the zirconium lanthanum compound, a lithium-contained compound, a gallium-contained compound, an aluminum-contained compound and a further lanthanum-contained compound into a second ball mill for grinding and then performing another oil bath assisted vacuum concentration and a second stage sintering operation to obtain a plurality of modified LLZO agglomerates; and placing the modified LLZO agglomerates into a jet mill and a wet grinding mill for grinding and then performing a water bath assisted vacuum concentration to obtain a plurality of modified LLZO powders.

### FIELD OF THE INVENTION

The present invention is related to solid electrolyte, and in particular to a method for manufacturing an oxide-base solid electrolyte of a lithium battery.

### BACKGROUND OF THE INVENTION

In prior arts, the method for manufacturing a solid electrolyte of a lithium battery by ZrO₂, La₂O₃ and Li₂CO₃ is placing the composite slurry formed by three initial compounds ZrO₂, La₂O₃ and Li₂CO₃ into a ball mill with a specific ratio for mixing and grinding, and then using oxygen to perform an one-time sintering reaction.

However, in above one-time sintering reaction, due to the different temperature and phase transition conditions in the powder groups, some oxides will have oxygen deficiency or insufficient energy, resulting in the inability to become the correct phase (cubic crystal system), which causes the phase transition process messy and inconsistent. As a result, the final product has tetragonal crystal lattices, cubic crystal lattices or cubic lattices. The crystal structure composed of tetragonal crystal lattices is less efficient in conducting lithium ions. Many adjustment methods are used to avoid above problems by extending sintering time, increase sintering temperature or using both at the same time. However, these adjustment methods make it difficult to unify the complex crystalline phases, and the extended sintering time and increased sintering temperature often accelerate the depletion of the lithium source, and even cause the degradation of the originally stabilized LLZO (lithium lanthanum zirconium oxide) having cubic crystalline due to the lack of lithium. In order to overcome this problem, most developers perform the supplementation of lithium source, resulting in a lengthy process, more material depletions and energy consumption, which is not conducive to the production and product control and makes it difficult to market the product. This problem is especially obvious in the case of bulk sintering.

Therefore, the present invention desires to provide a novel invention to solve above problem of above prior arts by using multiple stages of processing, which avoids the depletion of the lithium source and the difficulty in controlling the complex crystalline phases.

### SUMMARY OF THE INVENTION

Accordingly, for improving above mentioned defects in the prior art, the object of the present invention is to provide a method for manufacturing an oxide-base solid electrolyte of a lithium battery, wherein the first stage sintering operation is performed without lithium-contained compound and oxygen, and the nitrogen and argon are added to form an atmosphere for the stew protection. Even if the internal particles have uneven reaction or uneven temperature, those zirconium lanthanum compound (La₂Zr₂O₇) produced quickly during the reaction will not further react with the oxygen and lithium-contained compound to form a multi-phase crystal. Therefore, a stable zirconium lanthanum compound can be obtained in the first stage sintering operation. The lithium-contained compound and oxygen are only added to the reaction of the second stage sintering operation. Because the initial intermediates have stable and even phases, the initial intermediates can be reacted with the compounds of the second stage sintering operation to form modified LLZO particles formed by cubic crystal lattices. Moreover, without the addition of lithium-contained compound, the first stage sintering operation avoids the lithium-consuming behavior associated with tedious or lengthy sintering, and avoids the phase degradation and disintegration under the sintering due to equivalent variations. Therefore, the process yield is increased and the cost can be controlled. Furthermore, the mixture particle agglomerates in the second stage sintering operation are dispersed in the gridded sink, thereby increasing the reaction rate with the oxygen.

To achieve above object, the present invention provides a method for manufacturing an oxide-base solid electrolyte of a lithium battery, comprising the following steps of: placing at least one first salt compound into a first mill for grinding; then the at least one first salt compound being processed by a first evaporation, and then being processed by a first stage sintering operation to perform an oxygen-free sintering reaction for obtaining a first agglomerated compound; mixing the first agglomerated compound and at least one second salt compound; then the first agglomerated compound and at least one second salt compound being placed into a second mill for grinding; then the first reacted compound and at least one second salt compound being processed by a second evaporation, and then being processed by a second stage sintering operation to perform an oxygen assisted sintering reaction for obtaining a second agglomerated compound; and placing the second agglomerated compound into a third mill and a fourth mill for grinding; and then the second agglomerated compound being processed by a third evaporation for obtaining the oxide-base solid electrolyte; wherein the at least one first salt compound is at least one of a zirconium-contained compound and a lanthanum-contained compound; the at least one second salt compound is at least one of a lithium-contained compound, a gallium-contained compound, an aluminum-contained compound and a lanthanum-contained compound; the oxide-base solid electrolyte is a modified LLZO (modified lithium lanthanum zirconium oxide), which is a lithium lanthanum zirconium gallium aluminum compound; wherein the first mill is a ball mill; the second mill is a ball mill; the third mill is a jet mill; and the fourth mill is a wet grinding mill; wherein the first evaporation is an oil bath assisted vacuum concentration;

the second evaporation is an oil bath assisted vacuum concentration; the third evaporation is a water bath assisted vacuum concentration; wherein the first mill is pre-placed with a deionized water and a methanol; the second mill is pre-placed with a deionized water; the third mill is pre-placed with an ethanol anhydrous solvent; and the fourth mill is pre-placed with an ethanol and a water. The present invention further provides a method for manufacturing an oxide-base solid electrolyte of a lithium battery, comprising the following steps of: step A: taking a first ball mill, wherein a deionized water and a methanol are placed into the first ball mill; step B: placing a solid content formed by a zirconium-contained compound and a lanthanum-contained compound into the first ball mill, wherein the zirconium-contained compound and the lanthanum-contained compound are mixed with the deionized water and the methanol by using a specific mixing ratio for forming a composite slurry; then the first ball mill using a plurality of first zirconium ball for mixing and grinding the composite slurry to cause that the composite slurry has a specific particle size and forms a plurality of first mixture particles; step C: using an oil bath assisted rotary evaporator to perform an oil bath assisted vacuum concentration on the first mixture particles for evaporating the deionized water and the methanol in the first mixture particles to cause that a plurality of micro-holes are formed on a surface of each of the first mixture particles; step D: performing a first stage sintering operation to perform an argon & nitrogen atmosphere sintering reaction, wherein the first mixture particles are placed into a sintering furnace and a sintering is performed on the first mixture particles in a stew environment with a nitrogen and an argon; then the first mixture particles being reacted in a stew protection of the nitrogen and argon to form a zirconium lanthanum compound; step E: placing the zirconium lanthanum compound, a lithium-contained compound, a gallium-contained compound, an aluminum-contained compound and a further lanthanum-contained compound into a second ball mill having a deionized water; then the second ball mill using a plurality of second zirconium ball for mixing and grinding a composite material formed by the zirconium lanthanum compound, the lithium-contained compound, the gallium-contained compound, the aluminum-contained compound, the further lanthanum-contained compound and the deionized water to cause that the composite material has a particle size smaller than 1000 nm and forms a plurality of second mixture particles; step F: using the oil bath assisted rotary evaporator to perform another oil bath assisted vacuum concentration on the second mixture particles, wherein the deionized water in the second mixture particles are fully evaporated to cause that second mixture particles form a plurality of mixture particle agglomerates which are a plurality of sintered powders; then a plurality of micro-holes being formed on a surface of each of the mixture particle agglomerates; step G: performing a second stage sintering operation to perform an oxygen assisted sintering reaction, wherein the mixture particle agglomerates are sintered to perform the oxygen assisted sintering reaction, and in the mixture particle agglomerates, the surplus lanthanum-contained compound which is unreacted in the step D, the lithium-contained compound, gallium-contained compound aluminum-contained compound and the further lanthanum-contained compound added in the step E, are reacted with the zirconium lanthanum compound and an oxygen (O₂) in the oxygen assisted sintering reaction to produce a plurality of modified LLZO particles which are formed by a modified LLZO (modified lithium lanthanum zirconium oxide); then the modified LLZO particles being coalesced into a plurality of modified LLZO agglomerates, wherein each of the modified LLZO agglomerates has a plurality of cubic crystal lattices; step H: placing the modified LLZO agglomerates into a jet mill, wherein an ethanol anhydrous solvent is placed into the jet mill and mixed with the modified LLZO agglomerates to form a first composite solvent having the modified LLZO agglomerates; then the jet mill mixing and grinding the first composite solvent to form a modified LLZO slurry; step I: placing the modified LLZO slurry into a wet grinding mill, wherein an ethanol and a water are placed into the wet grinding mill and mixed with the modified LLZO slurry to form a second composite solvent having the modified LLZO slurry; then the wet grinding mill mixing and grinding the second composite solvent to form a plurality of modified LLZO pieces; step J: placing the modified LLZO pieces into a water bath assisted rotary evaporator to perform a water bath assisted vacuum concentration for evaporating the ethanol and water in the modified LLZO pieces to obtain a plurality of modified LLZO powders; wherein the zirconium-contained compound is selected from one of a zirconium nitrate (Zr(NO₃)₄), a zirconium dioxide (ZrO₂) and a zirconium(IV) hydroxide (Zr(OH)₄); the lanthanum-contained compound is selected from one of a lanthanum(III) nitrate (La(NO₃)₃), a lanthanum(III) oxide (La₂O₃) and a lanthanum hydroxide (La(OH)₃); the lithium-contained compound is selected from one of a lithium nitrate (LiNO₃), a lithium carbonate (Li₂CO₃) and a lithium hydroxide (LiOH); the gallium-contained compound is selected from one of a gallium nitrate (Ga(NO₃)₃), a gallium(III) oxide (Ga₂O₃) and a gallium hydroxide (Ga(OH)₃); and the aluminum-contained compound is selected from one of an aluminum oxide (Al₂O₃), an aluminum hydroxide (Al(OH)₃) and an aluminum nitrate (Al(NO₃)₃).

### BRIEF DESCRIPTION OF THE DRAWINGS

FIG. 1 is a steps flow diagram showing the process of the present invention.

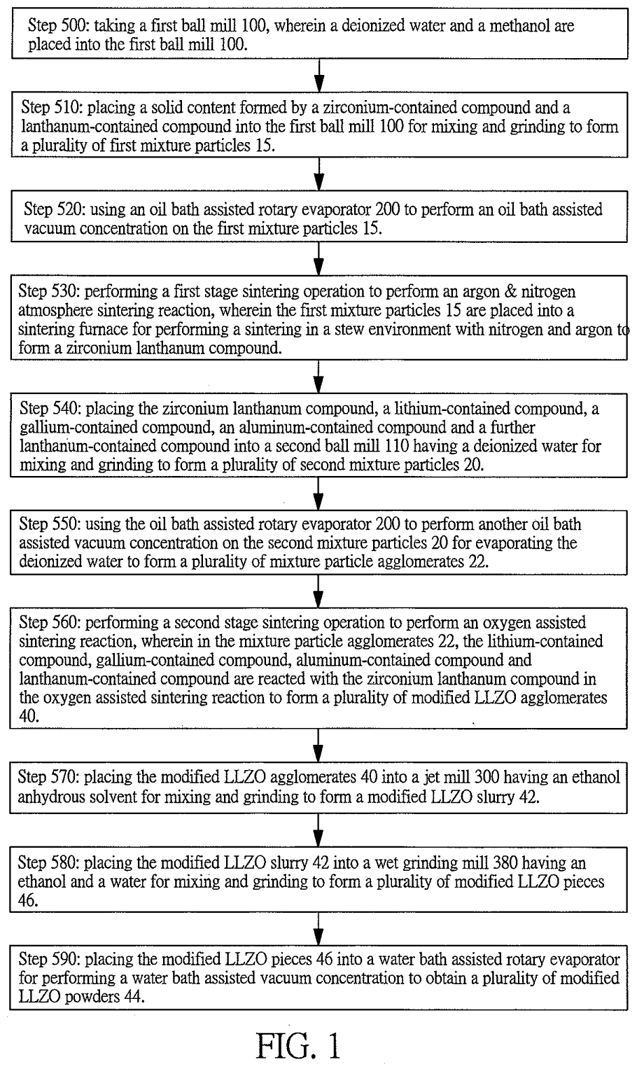

FIG. 2 is a schematic view showing the processing of the composite slurry of the present invention.

FIG. 3 is a schematic view showing the processing of the first mixture particles of the present invention.

FIG. 4 is a schematic view showing the processing of the second mixture particles and the mixture particle agglomerates of the present invention.

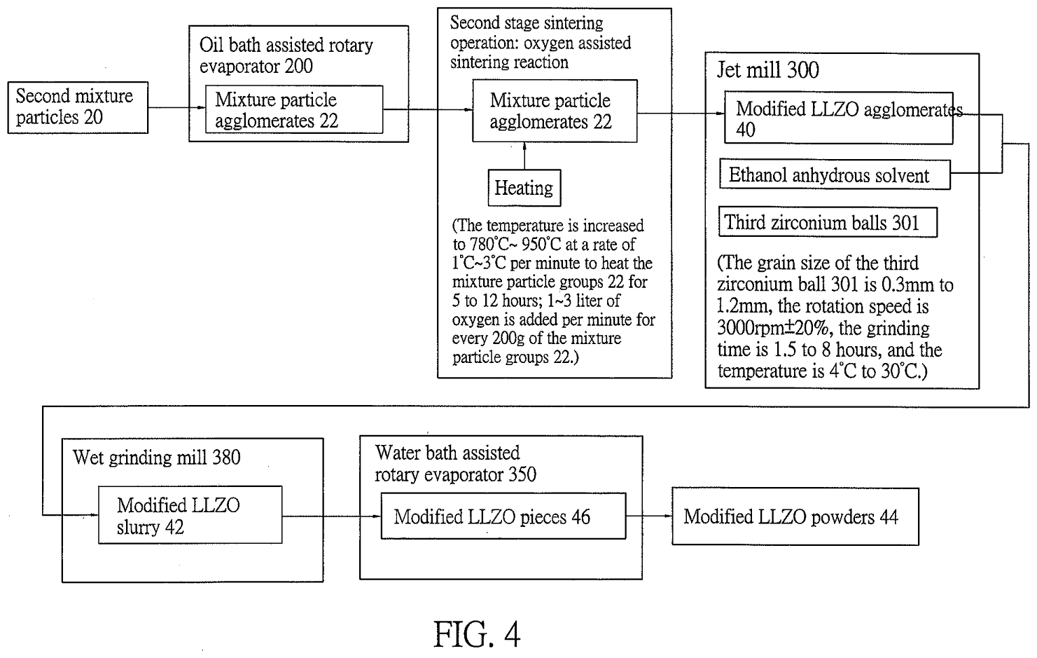

FIG. 5 is a schematic view showing the gridded sink of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

The present invention relates to a method for manufacturing an oxide-base solid electrolyte of a lithium battery. The method comprises the following steps of:

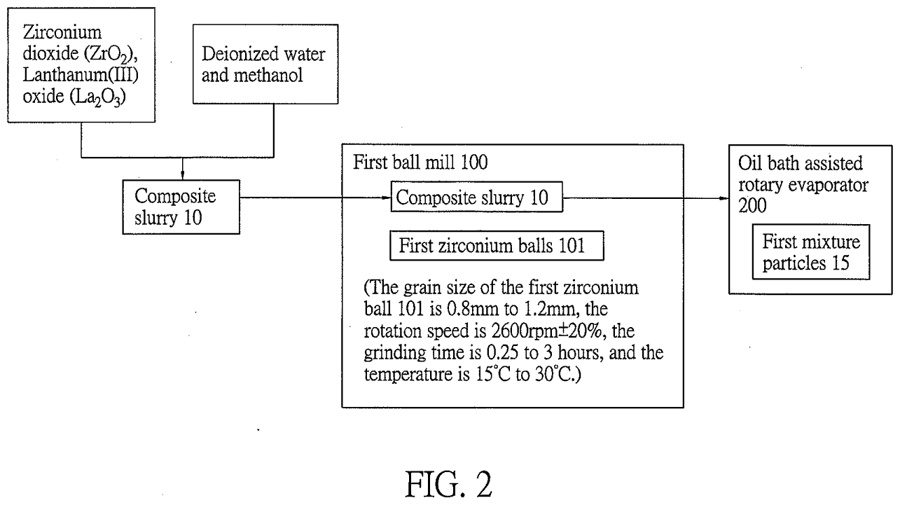

As illustrating in FIG. 2, taking a first ball mill 100, wherein a deionized water and a methanol are placed into the first ball mill 100 (step 500).

Placing a solid content formed by a zirconium-contained compound and a lanthanum-contained compound into the first ball mill 100. The zirconium-contained compound and lanthanum-contained compound are mixed with the deionized water and the methanol by using a specific mixing ratio for forming a composite slurry 10. The first ball mill 100 uses a plurality of first zirconium balls 101 for mixing and grinding the composite slurry 10 to cause that the composite slurry 10 has a particle size smaller than 500 nm and forms a plurality of first mixture particles 15 (step 510). A rotation speed of the first ball mill 100 is 2600 rpm±20%. Each of the first zirconium balls 101 has a grain size of 0.8 mm to 1.2 mm. A filling ratio of a total volume of the first zirconium balls 101 and the composite slurry 10 is 65% to 80%, which is a ratio of a total volume of the first zirconium balls 101 and the composite slurry 10 to a grinding volume of the first ball mill 100. A grinding time of the first ball mill 100 is 0.25 to 3 hours (preferably 0.25 to 1.5 hours). The mixing and grinding of the first ball mill 100 is performed by a first operation that the composite slurry 10 is placed into a first barrel trough A for mixing and then inputted into the first ball mill 100 for grinding, and then placed into a second barrel trough B for mixing and then inputted into the first ball mill 100 again for grinding, and then placed back into the first barrel trough A. The first operation is repeated for fully grinding the composite slurry 10 to form the first mixture particles 15. A temperature of the mixing and grinding of the first ball mill 100 is 15° C. to 30° C. (preferably 15° C. to 25° C.). A weight percentage of the solid content in the composite slurry 10 is 25 wt %˜40 wt %.

Wherein the zirconium-contained compound is selected from one of a zirconium nitrate (Zr(NO₃)₄), a zirconium dioxide (ZrO₂) and a zirconium(IV) hydroxide (Zr(OH)₄). The lanthanum-contained compound is selected from one of a lanthanum(III) nitrate (La(NO₃)₃), a lanthanum(III) oxide (La₂O₃) and a lanthanum hydroxide (La(OH)₃).

As illustrating in FIG. 2, using an oil bath assisted rotary evaporator 200 to perform an oil bath assisted vacuum concentration on the first mixture particles 15 for evaporating the deionized water and the methanol in the first mixture particles 15 (step 520).

A temperature of an oil path of the oil bath assisted rotary evaporator 200 is 120° C. A temperature of a condense water in the oil bath assisted rotary evaporator 200 is 0° C. to 4° C. The deionized water and the methanol in the first mixture particles 15 are fully evaporated to cause that a plurality of micro-holes are formed on a surface of each of the first mixture particles 15 for increasing a specific surface area (SSA) of each of the first mixture particles 15, which facilitates the next sintering adjustment and further increases rate of reaction and completeness of the subsequent reaction.

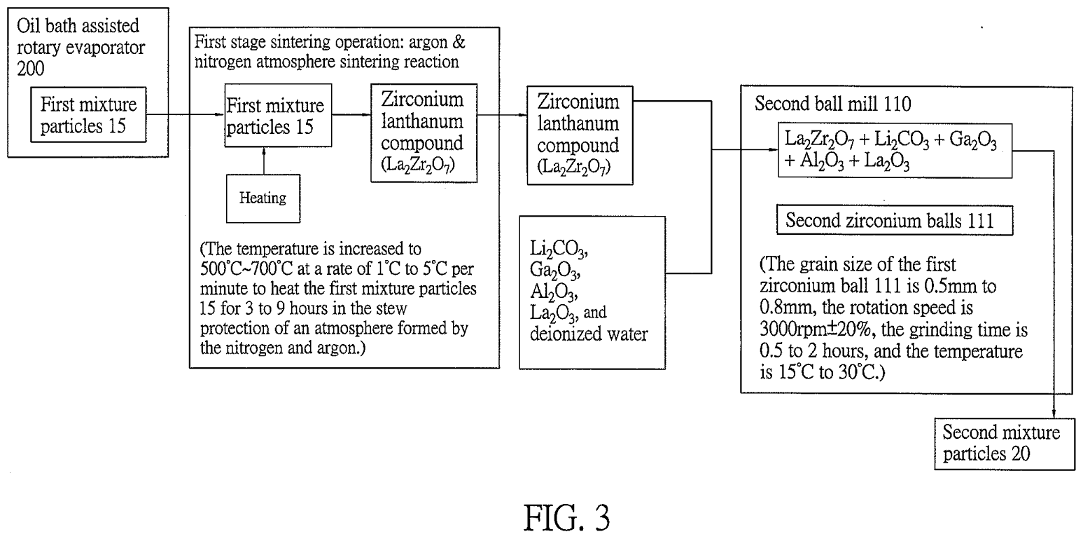

Performing a first stage sintering operation including an argon & nitrogen atmosphere sintering reaction, as shown in FIG. 3, wherein the first mixture particles 15 obtained in the step 520 are placed into a sintering furnace and a sintering is performed on the first mixture particles 15 in a stew environment with an atmosphere formed by a nitrogen (N₂) and an argon (Ar). The first mixture particles 15 are reacted in the stew protection of the nitrogen and argon to form a zirconium lanthanum compound (step 530). A ratio between a volume of the nitrogen and a volume of the argon is 98:2. A temperature of the sintering furnace is increased to 500° C.˜700° C. at a rate of 1° C. to 5° C. (preferably 2° C.) per minute to heat the first mixture particles 15 for 3 to 9 hours (preferably 6 hours) in the stew protection of the atmosphere. The atmosphere is replaced and replenished at 0.05 L to 0.15 L per minute.

In the first stage sintering operation, the first mixture particles 15 perform the argon & nitrogen atmosphere sintering reaction, which is an oxygen-free sintering reaction. The zirconium-contained compound and the lanthanum-contained compound of the first mixture particles 15 perform the reaction. In the first stage sintering operation, the zirconium lanthanum compound is produced according to a first chemical equation (1):

2 ZrO₂+La₂O₃→La₂Zr₂O₇ (1)

In above first chemical equation (1), a mole ratio between ZrO₂ and La₂O₃ is 2:1. The zirconium lanthanum compound is La₂Zr₂O₇. The first chemical equation (1) can still be performed without using above mole ratio, wherein some initial compounds which do not react will be remained in the final product. Therefore, the scope of the present invention includes above initial compounds in various different ratios. In the first chemical equation (1), the ZrO₂ and La₂O₃ are used as the zirconium-contained compound and the lanthanum-contained compound respectively, but are not to be used to confine the scope of the present invention.

Referring to FIG. 3, placing the zirconium lanthanum compound (La₂Zr₂O₇), a lithium-contained compound (e.g. Li₂CO₃), a gallium-contained compound (e.g. gallium(III) oxide (Ga₂O₃)), an aluminum-contained compound (e.g. Al₂O₃) and a further lanthanum-contained compound (e.g. La₂O₃) into a second ball mill 110 having a deionized water. The second ball mill 110 uses a plurality of second zirconium balls 111 for mixing and grinding a composite material formed by the zirconium lanthanum compound, the lithium-contained compound, the gallium-contained compound, the aluminum-contained compound, the further lanthanum-contained compound and the deionized water to cause that the composite material has a particle size smaller than 1000 nm and forms a plurality of second mixture particles 20 (step 540). A rotation speed of the second ball mill 110 is 3000 rpm±20%. Each of the second zirconium balls 111 has a grain size of 0.5 mm to 0.8 mm. A filling ratio of a total volume of the second zirconium balls 111 and the composite material is 65% to 80%, which is a ratio of a total volume of the second zirconium balls 111 and the composite material to a grinding volume of the second ball mill 110. A grinding time of the second ball mill 110 is 0.5 to 2 hours (preferably 0.5 to 1.5 hours). The mixing and grinding of the second ball mill 110 is performed by a second operation that the zirconium lanthanum compound (La₂Zr₂O₇) is placed into a third barrel trough C for mixing and then inputted into the second ball mill 110 for grinding, and then placed into a fourth barrel trough D for mixing and then inputted into the second ball mill 110 again for grinding, and then placed back into the third barrel trough C. The second operation is repeated for fully grinding the zirconium lanthanum compound (La₂Zr₂O₇) to form the second mixture particles 20. A temperature of the mixing and grinding of the second ball mill 110 is 15° C. to 30° C. (preferably 15° C. to 25° C.).

Using the oil bath assisted rotary evaporator 200 to perform another oil bath assisted vacuum concentration on the second mixture particles 20 for evaporating the deionized water in the second mixture particles 20 (step 550). The temperature of the oil path of the oil bath assisted rotary evaporator 200 is 120° C. The temperature of the condense water in the oil bath assisted rotary evaporator 200 is 0° C. to 4° C. The deionized water in the second mixture particles 20 are fully evaporated to cause that second mixture particles 20 form a plurality of mixture particle agglomerates 22 which are a plurality of sintered powders. A plurality of micro-holes are formed on a surface of each of the mixture particle agglomerates 22 for increasing a specific surface area (SSA) of each of the mixture particle agglomerates 22, which facilitates the next sintering adjustment and further increases rate of reaction and completeness of the subsequent reaction.

The lithium-contained compound is selected from one of a lithium nitrate (LiNO₃), a lithium carbonate (Li₂CO₃) and a lithium hydroxide (LiOH). The gallium-contained compound is selected from one of a gallium nitrate (Ga(NO₃)₃), a gallium(III) oxide (Ga₂O₃) and a gallium hydroxide (Ga(OH)₃). The aluminum-contained compound is selected from one of an aluminum oxide (Al₂O₃), an aluminum hydroxide (Al(OH)₃) and an aluminum nitrate (Al(NO₃)₃).

In the method of the present invention, the ZrO₂, La₂O₃, Li₂CO₃, Ga₂O₃ and Al₂O₃ are used as the zirconium-contained compound, the lanthanum-contained compound, the lithium-contained compound, the gallium-contained compound and the aluminum-contained compound respectively. The following processing also applies to all combinations of the compounds permitted in the preceding paragraph with respect to above five sources of the zirconium-contained compound, the lanthanum-contained compound, the lithium-contained compound, the gallium-contained compound and the aluminum-contained compound.

Performing a second stage sintering operation including an oxygen assisted sintering reaction, wherein a temperature of the mixture particle agglomerates 22 is increased to 780° C.˜950° C. for heating the mixture particle agglomerates 22 in an oxygen-riched atmosphere for 5 to 12 hours (preferably more than 6 hours). The mixture particle agglomerates 22 are sintered by above increasing temperature (780° C.˜950° C.) to perform the oxygen assisted sintering reaction, wherein in the mixture particle agglomerates 22, the lithium-contained compound, gallium-contained compound aluminum-contained compound and the further lanthanum-contained compound are reacted with the zirconium lanthanum compound (La₂Zr₂O₇) and an oxygen (O₂) in the oxygen assisted sintering reaction to produce a plurality of modified LLZO (modified lithium lanthanum zirconium oxide) particles which are formed by a modified

LLZO (modified lithium lanthanum zirconium oxide) (step 560). In the present invention, the Li₂CO₃, Ga₂O₃, Al₂O₃, La₂O₃ and O₂ perform the oxygen assisted sintering reaction with the La₂Zr₂O₇ in the second stage sintering operation.

In the second stage sintering operation, the temperature of the mixture particle agglomerates 22 is increased at a rate of 1° C. to 3° C. (preferably 2° C.˜4° C.) per minute. 1 liter to 3 liter of the oxygen is added per minute for every 200 g of mixture particle agglomerates 22. The temperature of the mixture particle agglomerates 22 is increased to 780° C.˜ 950° C. to heat the mixture particle agglomerates 22 for 5 to 12 hours (preferably more than 6 hours). The mixture particle agglomerates 22 produced by the reaction of the first stage sintering operation and the grinding of the second ball mill 110 perform a reaction of a second chemical equation (2) to produce the modified LLZO particles which are formed by cubic crystal lattices. The modified LLZO is Li_{(7-x-y)}Ga_{x/3}Al_{y/3}La₃Zr₂O₁₂. The Li_{(7-x-y)}Ga_{x/3}Al_{y/3}La₃Zr₂O₁₂ can be used as an oxide-base solid electrolyte of a lithium battery for conducting lithium ions. The gallium (Ga) and aluminum (Al) are contained in the Li_{(7-x-y)}Ga_{x/3}Al_{y/3}La₃Zr₂O₁₂, which causes that a equivalence ratio (ER) of the lithium (Li) of the Li_{(7-x-y)}Ga_{x/3}Al_{y/3}La₃Zr₂O₁₂ is reduced from 7 to 6.2˜6.9 compared to a normal LLZO (Li₇La₃Zr₂O₁₂) produced without the addition of the gallium (Ga) and aluminum (Al). The cubic crystal lattices of the Li_{(7-x-y)}Ga_{x/3}Al_{y/3}La₃Zr₂O₁₂ have larger channels for increasing the conduction rate of lithium ions.

In the prior art, the normal LLZO (Li₇La₃Zr₂O₁₂) is used as a solid electrolyte of an anode and a cathode of a battery. The lithium ion channels of the Li₇La₃Zr₂O₁₂ produce very limited lithium ion conduction. While the conduction has some effect, it is still not comparable to a liquid electrolyte and therefore limits the rate of lithium ion conduction, which limits the rate of charging and power production.

Therefore, the way the present invention provides to improve the disadvantage of above prior art is adding Ga₂O₃, Al₂O₃ to the prior chemical reaction “La₂Zr₂O₇+Li₂CO₃+O₂” to cause that some of the lithium (Li) of the normal LLZO (Li₇La₃Zr₂O₁₂) are replaced by the gallium (Ga) and aluminum (Al) to form the Li_{(7-x-y)}Ga_{x/3}Al_{y/3}La₃Zr₂O₁₂, which is a Ga&Al doped LLZO, that is, the modified LLZO obtained in the present invention. In the present invention, the Li_{(7-x-y)}Ga_{x/3}Al_{y/3}La₃Zr₂O₁₂ is a lithium lanthanum zirconium gallium aluminum compound produced by above five initial compounds (the zirconium-contained compound, lanthanum-contained compound, lithium-contained compound, gallium-contained compound and aluminum-contained compound) which are reacted in the first stage sintering operation and the second stage sintering operation.

In the second stage sintering operation, the second chemical equation (2) is:

2La₂Zr₂O₇+(7−x−y)Li₂CO₃+x/3Ga₂O₃+y/3Al₂O₃+La₂O₃→2Li_{(7-x-y)}Ga_{x/3}Ah_{y/3}La₃Zr₂O₁₂+(7−x−y)CO₂ (2)

The modified LLZO is produced according to above second chemical equation (2), wherein x>0, y>0 and 7−x−y>0.

In the Li_{(7-x-y)}Ga_{x/3}Al_{y/3}La₃Zr₂O₁₂, Ga and Al replace some of the Li of the Li₇La₃Zr₂O₁₂. Because gallium (Ga) and aluminum (Al) have higher charges and larger atomic sizes, the crystal structure formed by the cubic crystal lattices of the Li_{(7-x-y)}Ga_{x/3}Al_{y/3}La₃Zr₂O₁₂ creates larger lithium ion channels, which accelerates the rate of lithium ion conduction in the solid electrolyte.

The modified LLZO particles are coalesced into a plurality of modified LLZO agglomerates 40. Each of the modified LLZO agglomerates 40 has a plurality of cubic crystal lattices.

In the second chemical equation (2), a mole ratio between the La₂Zr₂O₇, Li₂CO₃, Ga₂O₃, Al₂O₃ and La₂O₃ is 2:(7−x−y):x/3:y/3:1. The second chemical equation (2) can still be performed without using above mole ratio, while some initial compounds which do not react will remain in the final product. Therefore, the scope of the present invention also includes the initial compounds in various different ratios. In the second chemical equation (2), 0<x<0.8, 0<y<0.8 and 0.1<x+y<0.8. Preferably, 0<x<0.35, 0<y<0.45 and 0.3<x+y<0.8.

In the present invention, when a first mole ratio between the zirconium-contained compound and the lanthanum-contained compound reacted in the first stage sintering operation, and a second mole ratio between the lithium-contained compound, the gallium-contained compound, the aluminum-contained compound and the lanthanum-contained compound reacted in the second stage sintering operation, are identical to the respective mole ratios of the reaction coefficients in the first chemical equation (1) and the second chemical equation (2) respectively, the first chemical equation (1) and the second chemical equation (2) achieve complete reactions. When the first mole ratio or the second mole ratio is different from the respective mole ratio of the reaction coefficients in the first chemical equation (1) or the second chemical equation (2) to cause that the complete reaction is not achieved, surplus molecules in the reaction of the first chemical equation (1) or the second chemical equation (2) form a plurality of impurities. Such operations which do not comply with the proportion and produce impurities are within the scope of the present invention.

Placing the modified LLZO agglomerates 40 into a jet mill 300, wherein an ethanol anhydrous solvent is placed into the jet mill 300 and mixed with the modified LLZO agglomerates 40 to form a first composite solvent having the modified LLZO agglomerates 40. A weight percentage of the modified LLZO agglomerates 40 in the first composite solvent is 25 wt % to 45 wt %.

The jet mill 300 uses a plurality of zirconium balls 301 for mixing and grinding the first composite solvent to form a modified LLZO slurry 42 (step 570). A particle size of the modified LLZO slurry 42 is smaller than 500 nm. A rotation speed of the jet mill 300 is 3000 rpm±20%. Each of the third zirconium balls 301 has a grain size of 0.3 mm to 1.2 mm. A filling ratio of a total volume of the third zirconium balls 301 and the first composite solvent is 75% to 90%, which is a ratio of a total volume of the third zirconium balls 301 and the first composite solvent to a grinding volume of the jet mill 300. A grinding time of the jet mill 300 is 1.5 to 8 hours (preferably 2 to 5 hours). A temperature of the mixing and grinding of the jet mill 300 is 4° C. to 30° C. (preferably 8° C. to 20° C.).

Placing the modified LLZO slurry 42 into a wet grinding mill 380, wherein an ethanol and a water are placed into the wet grinding mill 380 and mixed with the modified LLZO slurry 42 to form a second composite solvent having the modified LLZO slurry 42 (step 580). A weight percentage of the modified LLZO slurry 42 in the second composite solvent is 25 wt % to 45 wt %.

The wet grinding mill 380 uses a plurality of zirconium balls 381 for mixing and grinding the second composite solvent to form a plurality of modified LLZO pieces 46 which have smaller particle sizes. A rotation speed of the wet grinding mill 380 is 3200 rpm±15%. Each of the fourth zirconium balls 381 has a grain size of 0.3 mm to 0.5 mm. A filling ratio of a total volume of the fourth zirconium balls 381 and the second composite solvent is 80% to 95%, which is a ratio of a total volume of the fourth zirconium balls 381 and the second composite solvent to a grinding volume of the wet grinding mill 380. A grinding time of the wet grinding mill 380 is 2 to 8 hours (preferably 2 to 4 hours). A temperature of the mixing and grinding of the wet grinding mill 380 is 4° C. to 30° C. (preferably 8° C. to 20° C.).

Placing the modified LLZO pieces 46 into a water bath assisted rotary evaporator 350 to perform a water bath assisted vacuum concentration in 40° C.˜60° C. for evaporating the ethanol and water in the modified LLZO pieces 46 to obtain a plurality of meticulous modified LLZO powders 44 formed by the modified LLZO. The modified LLZO is an oxide-base solid electrolyte for a lithium battery. A temperature of a condense water in the water bath assisted rotary evaporator 350 is 0° C. to 4° C. During the removing of the ethanol and water, a drying concentration is performed on the modified LLZO pieces 46 and an operation temperature is reduced to a room temperature for evaporating the ethanol and water in the modified LLZO pieces 46 (step 590).

In the first stage sintering operation, the nitrogen and argon are added to form the atmosphere for the stew protection, which produces a high purity zirconium lanthanum compound (La₂Zr₂O₇). When the reaction of the first stage sintering operation is complete, the reacted intermediates having an identical phase are formed. The oxygen is added only in the second stage sintering operation for performing the reaction of the second chemical equation (2), which produces a crystal structure mainly formed by the cubic crystal lattices. This crystal structure has a better efficiency of conducting lithium ions.

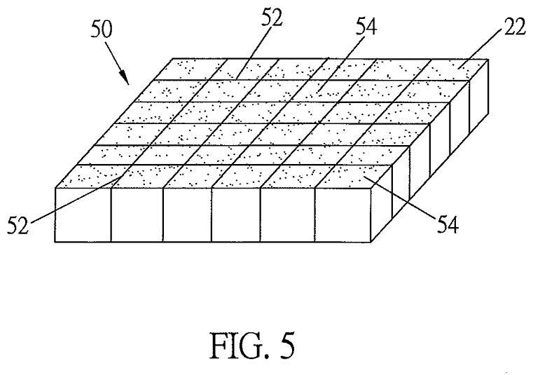

In order to accelerate the reaction rate, the mixture particle agglomerates 22 can be placed in a gridded sink 50 before performing the second stage sintering operation, as shown in FIG. 5. The gridded sink 50 is formed by a storage sink having a plurality of storage grids 54 which are separated by a plurality of isolating fences 52. The mixture particle agglomerates 22 produced by the first ball mill 100 and the first stage sintering operation are placed into the storage grids 54 respectively, which cause that the reaction rate of the mixture particle agglomerates 22 and the oxygen in the second stage sintering operation is increased because the mixture particle agglomerates 22 are is dispersed in the storage grids 54.

The advantages of the present invention are that the first stage sintering operation is performed without lithium-contained compound and oxygen, and the nitrogen and argon are added to form an atmosphere for the stew protection. Even if the internal particles have uneven reaction or uneven temperature, those zirconium lanthanum compound (La₂Zr₂O₇) produced quickly during the reaction will not further react with the oxygen and lithium-contained compound to form a multi-phase crystal. Therefore, a stable zirconium lanthanum compound can be obtained in the first stage sintering operation. The lithium-contained compound and oxygen are only added to the reaction of the second stage sintering operation. Because the initial intermediates have stable and even phases, the initial intermediates can be reacted with the compounds of the second stage sintering operation to form modified LLZO particles formed by cubic crystal lattices. Moreover, without the addition of lithium-contained compound, the first stage sintering operation avoids the lithium-consuming behavior associated with tedious or lengthy sintering, and avoids the phase degradation and disintegration under the sintering due to equivalent variations. Therefore, the process yield is increased and the cost can be controlled. Furthermore, the mixture particle agglomerates in the second stage sintering operation are dispersed in the gridded sink, thereby increasing the reaction rate with the oxygen.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for manufacturing an oxide-base solid electrolyte of a lithium battery, comprising the following steps of:
placing at least one first salt compound into a first mill for grinding; then the at least one first salt compound being processed by a first evaporation, and then being processed by a first stage sintering operation to perform an oxygen-free sintering reaction for obtaining a first agglomerated compound;
mixing the first agglomerated compound and at least one second salt compound; then the first agglomerated compound and at least one second salt compound being placed into a second mill for grinding; then the first reacted compound and at least one second salt compound being processed by a second evaporation, and then being processed by a second stage sintering operation to perform an oxygen assisted sintering reaction for obtaining a second agglomerated compound; and
placing the second agglomerated compound into a third mill and a fourth mill for grinding; and then the second agglomerated compound being processed by a third evaporation for obtaining the oxide-base solid electrolyte.

2. The method for manufacturing the oxide-base solid electrolyte of the lithium battery as claimed in claim 1, wherein the at least one first salt compound is at least one of a zirconium-contained compound and a lanthanum-contained compound; the at least one second salt compound is at least one of a lithium-contained compound, a gallium-contained compound, an aluminum-contained compound and a lanthanum-contained compound; the oxide-base solid electrolyte is a modified LLZO (modified lithium lanthanum zirconium oxide), which is a lithium lanthanum zirconium gallium aluminum compound;
wherein the first mill is a ball mill; the second mill is a ball mill; the third mill is a jet mill; and the fourth mill is a wet grinding mill;
wherein the first evaporation is an oil bath assisted vacuum concentration; the second evaporation is an oil bath assisted vacuum concentration; the third evaporation is a water bath assisted vacuum concentration; and
wherein the first mill is pre-placed with a deionized water and a methanol; the second mill is pre-placed with a deionized water; the third mill is pre-placed with an ethanol anhydrous solvent; and the fourth mill is pre-placed with an ethanol and a water.

3. A method for manufacturing an oxide-base solid electrolyte of a lithium battery, comprising the following steps of:
step A: taking a first ball mill, wherein a deionized water and a methanol are placed into the first ball mill;
step B: placing a solid content formed by a zirconium-contained compound and a lanthanum-contained compound into the first ball mill, wherein the zirconium-contained compound and the lanthanum-contained compound are mixed with the deionized water and the methanol by using a specific mixing weight ratio for forming a composite slurry; then the first ball mill using a plurality of first zirconium ball for mixing and grinding the composite slurry to cause that the composite slurry has a specific particle size and forms a plurality of first mixture particles;
step C: using an oil bath assisted rotary evaporator to perform an oil bath assisted vacuum concentration on the first mixture particles for evaporating the deionized water and the methanol in the first mixture particles to cause that a plurality of micro-holes are formed on a surface of each of the first mixture particles;
step D: performing a first stage sintering operation to perform an argon & nitrogen atmosphere sintering reaction, wherein the first mixture particles are placed into a sintering furnace and a sintering is performed on the first mixture particles in a stew environment with a nitrogen (N₂) and an argon (Ar); then the first mixture particles being reacted in a stew protection of the nitrogen and argon to form a zirconium lanthanum compound;
step E: placing the zirconium lanthanum compound, a lithium-contained compound, a gallium-contained compound, an aluminum-contained compound and a further lanthanum-contained compound into a second ball mill having a deionized water; then the second ball mill using a plurality of second zirconium ball for mixing and grinding a composite material formed by the zirconium lanthanum compound, the lithium-contained compound, the gallium-contained compound, the aluminum-contained compound, the further lanthanum-contained compound and the deionized water in the second ball mill to cause that the composite material has a particle size smaller than 1000 nm and forms a plurality of second mixture particles;
step F: using the oil bath assisted rotary evaporator to perform another oil bath assisted vacuum concentration on the second mixture particles, wherein the deionized water in the second mixture particles are fully evaporated to cause that second mixture particles form a plurality of mixture particle agglomerates which are a plurality of sintered powders; then a plurality of micro-holes being formed on a surface of each of the mixture particle agglomerates;
step G: performing a second stage sintering operation to perform an oxygen assisted sintering reaction, wherein the mixture particle agglomerates are sintered to perform the oxygen assisted sintering reaction, and in the mixture particle agglomerates, the lithium-contained compound, gallium-contained compound aluminum-contained compound and the further lanthanum-contained compound are reacted with the zirconium lanthanum compound and an oxygen (O₂) in the oxygen assisted sintering reaction to produce a plurality of modified LLZO (modified lithium lanthanum zirconium oxide) particles which are formed by a modified LLZO (modified lithium lanthanum zirconium oxide); then the modified LLZO particles being coalesced into a plurality of modified LLZO agglomerates, wherein each of the modified LLZO agglomerates has a plurality of cubic crystal lattices;
step H: placing the modified LLZO agglomerates into a jet mill, wherein an ethanol anhydrous solvent is placed into the jet mill and mixed with the modified LLZO agglomerates to form a first composite solvent having the modified LLZO agglomerates; then the jet mill mixing and grinding the first composite solvent to form a modified LLZO slurry;
step I: placing the modified LLZO slurry into a wet grinding mill, wherein an ethanol and a water are placed into the wet grinding mill and mixed with the modified LLZO slurry to form a second composite solvent having the modified LLZO slurry; then the wet grinding mill mixing and grinding the second composite solvent to form a plurality of modified LLZO pieces;
step J: placing the modified LLZO pieces into a water bath assisted rotary evaporator to perform a water bath assisted vacuum concentration for evaporating the ethanol and water in the modified LLZO pieces to obtain a plurality of modified LLZO powders;
wherein the zirconium-contained compound is selected from one of a zirconium nitrate (Zr(NO₃)₄), a zirconium dioxide (ZrO₂) and a zirconium(IV) hydroxide (Zr(OH)₄); the lanthanum-contained compound is selected from one of a lanthanum(III) nitrate (La(NO₃)₃), a lanthanum(III) oxide (La₂O₃) and a lanthanum hydroxide (La(OH)₃); the lithium-contained compound is selected from one of a lithium nitrate (LiNO₃), a lithium carbonate (Li₂CO₃) and a lithium hydroxide (LiOH); the gallium-contained compound is selected from one of a gallium nitrate (Ga(NO₃)₃), a gallium(III) oxide (Ga₂O₃) and a gallium hydroxide (Ga(OH)₃); and the aluminum-contained compound is selected from one of an aluminum oxide (Al₂O₃), an aluminum hydroxide (Al(OH)₃) and an aluminum nitrate (Al(NO₃)₃).

4. The method for manufacturing the oxide-base solid electrolyte of the lithium battery as claimed in claim 3, wherein the zirconium-contained compound is a zirconium dioxide (ZrO₂); the lanthanum-contained compound is a lanthanum(III) oxide (La₂O₃); the lithium-contained compound is a lithium carbonate (Li₂CO₃); the gallium-contained compound is a gallium(III) oxide (Ga₂O₃); the aluminum-contained compound is an aluminum oxide (Al₂O₃);
wherein in the first stage sintering operation, the zirconium lanthanum compound is La₂Zr₂O₇ which is produced according to a first chemical equation:
2 ZrO2+La₂O₃→La₂Zr₂O₇; and
wherein in the second stage sintering operation, the modified LLZO is Li_{(7-x-y)}Ga_{x/3}Al_{y/3}La₃Zr₂O₁₂ which is produced according to a second chemical equation:
2La₂Zr₂O₇+(7−x−y)Li₂CO₃+x/3Ga₂O₃+y/3Al₂O₃+La₂O₃→2Li_{(7-x-y)}Ga_{x/3}Al_{y/3}La₃Zr₂O₁₂+(7−x−y)CO₂, wherein x>0, y>0 and 7−x−y>0.

5. The method for manufacturing the oxide-base solid electrolyte of the lithium battery as claimed in claim 4, wherein in the first chemical equation, a mole ratio between the ZrO₂ and La₂O₃ is 2:1; and in the second chemical equation, a mole ratio between the La₂Zr₂O₇, Li₂CO₃, Ga₂O₃, Al₂O₃ and La₂O₃ is 2:(7−x−y):x/3:y/3:1, wherein 0<x<0.8, 0<y<0.8 and 0.1<x+y<0.8.

6. The method for manufacturing the oxide-base solid electrolyte of the lithium battery as claimed in claim 3, wherein in the step B, a weight percentage of the solid content in the composite slurry is 25 wt %˜40 wt %.

7. The method for manufacturing the oxide-base solid electrolyte of the lithium battery as claimed in claim 3, wherein in the step B, the specific particle size of the composite slurry is smaller than 500 nm; a rotation speed of the first ball mill is 2600 rpm±20%; each of the first zirconium balls has a grain size of 0.8 mm to 1.2 mm; a filling ratio of a total volume of the first zirconium balls and the composite slurry is 65% to 80%; a grinding time of the first ball mill is 0.25 to 3 hours; and a temperature of the mixing and grinding of the first ball mill is 15° C. to 30° C.

8. The method for manufacturing the oxide-base solid electrolyte of the lithium battery as claimed in claim 3, wherein in the step D, a ratio between a volume of the nitrogen and a volume of the argon is 98:2.

9. The method for manufacturing the oxide-base solid electrolyte of the lithium battery as claimed in claim 3, wherein in the step D, in the first stage sintering operation, a temperature of the sintering furnace is increased to 500° C.˜700° C. at a rate of 1° C. to 5° C. per minute to heat the first mixture particles for 3 to 9 hours in the stew protection of an atmosphere formed by the nitrogen and the argon; and the atmosphere is replaced and replenished at 0.05 L to 0.15 L per minute.

10. The method for manufacturing the oxide-base solid electrolyte of the lithium battery as claimed in claim 3, wherein in the step E, a rotation speed of the second ball mill is 3000 rpm±20%; each of the second zirconium balls has a grain size of 0.5 mm to 0.8 mm; a filling ratio of a total volume of the second zirconium balls and the composite material is 65% to 80%; a grinding time of the second ball mill is 0.5 to 2 hours; and a temperature of the mixing and grinding of the second ball mill is 15° C. to 30° C.

11. The method for manufacturing the oxide-base solid electrolyte of the lithium battery as claimed in claim 3, wherein in the step G, in the second stage sintering operation, a temperature of the mixture particle agglomerates is increased to 780° C.˜950° C. for heating the mixture particle agglomerates in an oxygen-riched atmosphere for 5 to 12 hours.

12. The method for manufacturing the oxide-base solid electrolyte of the lithium battery as claimed in claim 3, wherein in the step H, a weight percentage of the modified LLZO agglomerates in the first composite solvent is 25 wt % to 45 wt %; the jet mill uses a plurality of third zirconium balls for mixing and grinding the first composite solvent to form the modified LLZO slurry; a particle size of the modified LLZO slurry is smaller than 500 nm; a rotation speed of the jet mill is 3000 rpm±20%; each of the third zirconium balls has a grain size of 0.3 mm to 1.2 mm; a filling ratio of a total volume of the third zirconium balls and the first composite solvent is 75% to 90%; a grinding time of the jet mill is 1.5 to 8 hours; A temperature of the mixing and grinding of the jet mill is 4° C. to 30° C.;
wherein in the step I, a weight percentage of the modified LLZO slurry in the second composite solvent is 25 wt % to 45 wt %; the wet grinding mill uses a plurality of fourth zirconium balls for mixing and grinding the second composite solvent to form a plurality of modified LLZO pieces which have smaller particle sizes; a rotation speed of the wet grinding mill is 3200 rpm±15%; each of the fourth zirconium balls has a grain size of 0.3 mm to 0.5 mm; a filling ratio of a total volume of the fourth zirconium balls and the second composite solvent is 80% to 95%; a grinding time of the wet grinding mill is 2 to 8 hours; A temperature of the mixing and grinding of the wet grinding mill is 4° C. to 30° C.

13. The method for manufacturing the oxide-base solid electrolyte of the lithium battery as claimed in claim 4, wherein in the step G, in the second stage sintering operation, the temperature of the mixture particle agglomerates is increased at a rate of 1° C. to 3° C. per minute; 1 liter to 3 liter of the oxygen is added per minute for every 200 g of mixture particle agglomerates 22; the temperature of the mixture particle agglomerates is increased to 780° C.˜950° C. to heat the mixture particle agglomerates for 5 to 12 hours; the mixture particle agglomerates produced by the reaction of the first stage sintering operation and the grinding of the second ball mill perform the reaction to produce the modified LLZO particles which are formed by cubic crystal lattices; and the modified LLZO is used as the oxide-base solid electrolyte of the lithium battery for conducting lithium ions.

14. The method for manufacturing the oxide-base solid electrolyte of the lithium battery as claimed in claim 3, wherein the mixture particle agglomerates are placed in a gridded sink before performing the second stage sintering operation; the gridded sink is formed by a storage sink having a plurality of storage grids which are separated by a plurality of isolating fences; the mixture particle agglomerates are placed into the storage grids respectively, which cause that the reaction rate of the mixture particle agglomerates and the oxygen in the second stage sintering operation is increased because the mixture particle agglomerates are is dispersed in the storage grids.

15. The method for manufacturing the oxide-base solid electrolyte of the lithium battery as claimed in claim 4, wherein when a first mole ratio between the zirconium-contained compound and the lanthanum-contained compound reacted in the first stage sintering operation, and a second mole ratio between the lithium-contained compound, the gallium-contained compound, the aluminum-contained compound and the lanthanum-contained compound reacted in the second stage sintering operation, are identical to the respective mole ratios of the reaction coefficients in the first chemical equation and the second chemical equation respectively, the first chemical equation and the second chemical equation achieve complete reactions; and when the first mole ratio or the second mole ratio is different from the respective mole ratio of the reaction coefficients in the first chemical equation or the second chemical equation to cause that the complete reaction is not achieved, surplus molecules in the reaction of the first chemical equation or the second chemical equation form a plurality of impurities.

16. The method for manufacturing the oxide-base solid electrolyte of the lithium battery as claimed in claim 3, wherein in the step B, the mixing and grinding of the first ball mill is performed by a first operation that the composite slurry is placed into a first barrel trough for mixing and then inputted into the first ball mill for grinding, and then placed into a second barrel trough for mixing and then inputted into the first ball mill again for grinding, and then placed back into the first barrel trough; the first operation is repeated for fully grinding the composite slurry.

17. The method for manufacturing the oxide-base solid electrolyte of the lithium battery as claimed in claim 3, wherein in the step C, a temperature of an oil path of the oil bath assisted rotary evaporator is 120° C.; and a temperature of a condense water in the oil bath assisted rotary evaporator is 0° C. to 4° C.

18. The method for manufacturing the oxide-base solid electrolyte of the lithium battery as claimed in claim 3, wherein in the step E, the mixing and grinding of the second ball mill is performed by a second operation that the zirconium lanthanum compound is placed into a third barrel trough for mixing and then inputted into the second ball mill for grinding, and then placed into a fourth barrel trough for mixing and then inputted into the second ball mill again for grinding, and then placed back into the third barrel trough; the second operation is repeated for fully grinding the zirconium lanthanum compound.

19. The method for manufacturing the oxide-base solid electrolyte of the lithium battery as claimed in claim 3, wherein in the step F, a temperature of an oil path of the oil bath assisted rotary evaporator is 120° C.; and a temperature of a condense water in the oil bath assisted rotary evaporator is 0° C. to 4° C.
